(19) United States
(12) Patent Application Publication
(10) Pub. No.: US 2011/0131405 A1
(43) Pub. Date: Jun. 2, 2011

(54) INFORMATION PROCESSING APPARATUS

(75) Inventor: Makito Ogura, Hino-shi (JP)

(73) Assignee: KABUSHIKI KAISHA TOSHIBA, Tokyo (JP)

(21) Appl. No.: 12/724,697

(22) Filed: Mar. 16, 2010

(30) Foreign Application Priority Data
Nov. 30, 2009 (JP) 2009-272630

(51) Int. Cl. G06F 17/00; H04L 9/00; H04L 9/32; G06F 21/00

(52) U.S. Cl. 713/150; 715/234; 726/7

(57) ABSTRACT

An information processing apparatus includes a monitoring unit configured to monitor transition of Web pages displayed by a browser, a determination unit configured to determine whether a current Web page is a page of a particular type when the transition of the Web pages displayed by the browser has occurred, an extraction unit configured to extract a feature quantity from the current Web page when the current Web page is not the page of the particular type, and a providing unit configured to provide a supplementary service related to the current Web page, using the extracted feature quantity.

### CROSS-REFERENCE TO RELATED APPLICATIONS

This application is based upon and claims the benefit of priority from prior Japanese Patent Application No. 2009-272630, filed Nov. 30, 2009, the entire contents of which are incorporated herein by reference.

### BACKGROUND

1. Field

The present invention relates to a supplementary service provided during Web page browsing.

2. Description of the Related Art

A supplementary service provided during Web page browsing has been proposed recently. For instance, a service providing system (hereinafter referred to as “the interest linking system”) for displaying a link to a Web page that is associated with a currently browsed Web page and corresponds to the instruction (concerning interest or search direction) of a user has been proposed. The interest linking system can recommend a Web page that may rouse the interest of the user. Thus, this system may well enhance convenience in Web browsing. In particular, the interest linking system can reduce the number of operations necessary for the user to access a Web page in which the user is very much interested, and is therefore suitable for an information processing terminal (e.g., a mobile terminal) that does not have a sufficient user interface function. However, to acquire a recommended Web page, the interest linking system must transmit, to a search site, a keyword extracted from a user browsing Web page, and acquire the result of search. From this structure, it can be occurred that a keyword will be extracted from a Web page which including information to be kept secret, and be leaked to the outside.

Jpn. Pat. Appin. KOKAI Publication No. 2008-117152 discloses a history information display apparatus in which a log concerning the operation unit of the apparatus is recorded. In this apparatus, a user can manually designate exclusion of certain data from the log. The designated data is not stored in the history information display apparatus. Thus, the history information display apparatus can filter information based on manual designation of data to be excluded from the log. However, it is troublesome for the user to perform such manual designation as the above, and hence the convenience of the apparatus for the user is degraded.

Jpn. Pat. Appin. KOKAI Publication No. 2005-301759 discloses a search apparatus which performs crawling based on a keyword or the like, and obtains information about contents. In the crawling procedure, the search apparatus excludes information on illegitimate content from a search result. More specifically, the search apparatus excludes, from crawling targets, information that does not conform to content provision rules. This search apparatus filters information on illegitimate content at the server side. Even if the technique of this publication is applied to part (e.g., the search site) of the interest linking system, leakage to the outside of a keyword extracted from a Web page to be kept secret cannot be suppressed.

### SUMMARY

According to an aspect of the invention, there is provided an information processing apparatus comprising: a monitoring unit configured to monitor transition of Web pages displayed by a browser; a determination unit configured to determine whether a current Web page is a page of a particular type when the transition of the Web pages displayed by the browser has occurred; an extraction unit configured to extract a feature quantity from the current Web page when the current Web page is not the page of the particular type; and a providing unit configured to provide a supplementary service related to the current Web page, using the extracted feature quantity.

According to another aspect of the invention, there is provided an information processing apparatus, comprising: a determination unit configured to determine whether received data is a page of a particular type when the received data is a Web page; a parser configured to analyze the received data and generate a current Web page when the received data is the Web page and is not the page of the particular type; an extraction unit configured to extract a feature quantity from the current Web page; and a providing unit configured to provide a supplementary service related to the current Web page, using the extracted feature quantity.

According to another aspect of the invention, there is provided an information processing apparatus comprising: an acquiring unit configured to acquire a Web page; a determination unit configured to determine whether an acquired Web page is a page of a particular type; an extraction unit configured to extract a keyword from the acquired Web page when the acquired Web page is not the page of the particular type; and a generation unit configured to generate a search query based on the keyword.

### BRIEF DESCRIPTION OF THE SEVERAL VIEWS OF THE DRAWING

FIG. 1 is a block diagram illustrating an information processing apparatus according to a first embodiment;

FIG. 2 is a flowchart illustrating part of the operation of the interest linking engine shown in FIG. 1;

FIG. 3 is a flowchart illustrating the entire operation of the interest linking engine shown in FIG. 1;

FIG. 4 is a block diagram illustrating an information processing apparatus according to a second embodiment;

FIG. 5 is a flowchart illustrating the operation of the page type determination unit shown in FIG. 4; and

FIG. 6 is a flowchart illustrating the operation of the interest linking engine shown in FIG. 4.

### DETAILED DESCRIPTION

Embodiments of the invention will be described with reference to the accompanying drawings.

### First Embodiment

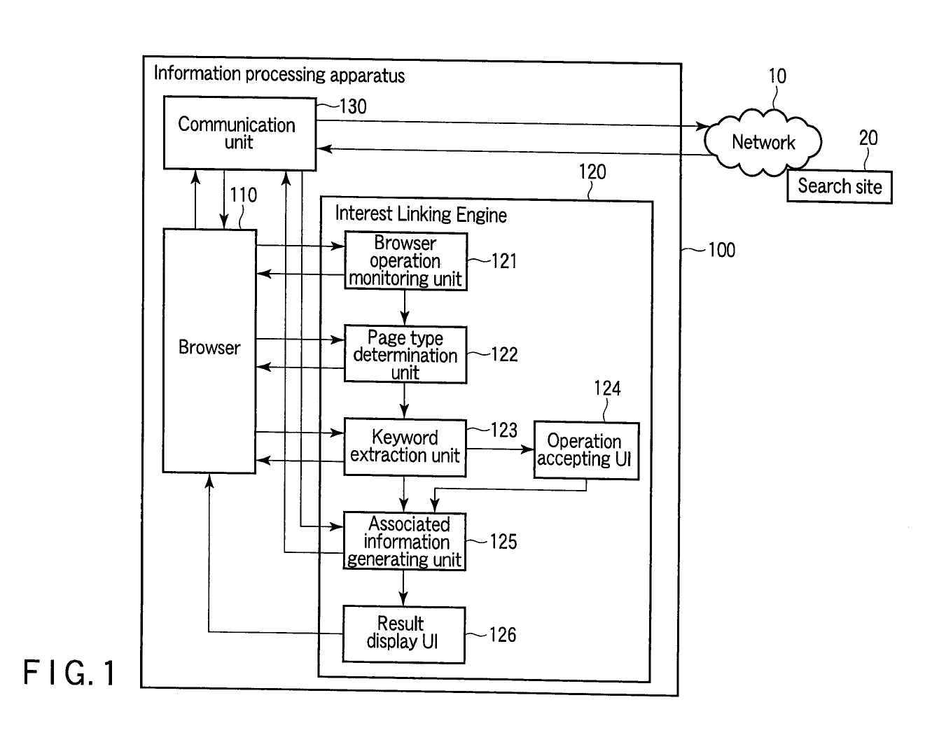

As shown in FIG. 1, an information processing apparatus 100 according to a first embodiment of the invention comprises a browser 110, an interest linking engine 120 and a communication unit 130. The information processing apparatus 100 is an apparatus usable to browse Web pages, such as a mobile phone, a PC, a portable media player, a video game machine, a TV set. Further, the information processing apparatus 100 has a fundamental hardware configuration of a processor, a memory, a display, etc., although they are not shown.

The browser 110 is a software module installed in the information processing apparatus 100. The browser 110 may be a general Web browser. The browser 110 has functionality equivalent or similar to that of a general one. For instance, the browser 110 accepts the URL (Uniform Resource Locator) of a Web page a user wishes to browse, or acquires, via the Internet, an intranet or a local file, the source data of a Web page with a URL designated by the user. Further, the browser 110 interprets acquired source data, and appropriately displays characters, images, etc. Yet further, the browser 110 may provide external with interfaces for enabling part of the data or the functionality of the browser to be used by other applications, or for enabling the status of the browser to be reported to the applications.

The interest linking engine 120 is a software module installed in the information processing apparatus 100. The interest linking engine 120 provides the user with associated information including link information that indicates a link to an associated Web page of the currently browsed Web page. The interest linking engine 120 may be replaced with another supplementary service providing engine. The supplementary service providing engine uses the feature quantity of the currently browsed Web page to provide an arbitrary supplementary service.

The interest linking engine 120 comprises a browser operation monitoring unit 121, a page type determination unit 122, a keyword extraction unit 123, an operation accepting UI (user interface) 124, an associated information generating unit 125 and a result display UI 126.

The browser operation monitoring unit 121 monitors transition (move) of Web pages displayed by the browser 110. For instance, the browser operation monitoring unit 121 uses an interface provided by the browser 110 to pre-register a callback for receiving a signal indicating transition of Web pages. When the browser operation monitoring unit 121 detects transition of Web pages, the page type determination unit 122 starts to operate.

When transition, from one to another, of Web pages displayed by the browser 110 occurs, the page type determination unit 122 determines whether said another Web page (hereinafter referred to as the “current Web page”) is a particular type page. For instance, the page type determination unit 122 acquires the current Web page using the interface provided by the browser 110, and determines whether it is the particular type page. If the page type determination unit 122 determines that the current Web page is not the particular type page, it sends a keyword extraction request to the keyword extraction unit 123. Detailed descriptions will be later given of the determination process of the page type determination unit 122, and a page of the particular type.

The keyword extraction unit 123 extracts a feature quantity, such as a keyword, from the source data of the current Web page. For instance, the keyword extraction unit 123 uses an interface provided by the browser 110 to acquire the source data of the current Web page. Various methods can be used to extract the feature quantity. The feature quantity is not limited to a keyword, but may be that of an image feature quantity or sound feature quantity. However, in the description below, it is assumed for simplification that the feature quantity indicates a keyword. After the keyword extraction unit 123 completes keyword extraction, it reports the completion to the operation accepting UI 124.

The operation accepting UI 124 accepts a user's instruction operation for generating associated information. For example, the operation accepting UI 124 displays, on the screen of the browser 110, GUI components (a button, an icon, a soft key, etc.) indicating instruction options. The instruction operation to be accepted by the operation accepting UI 124 is, for example, a choice of the category (news, shopping, photographs) of the associated information requested by the user. The operation accepting UI 124 provides the associated information generating unit 125 with data indicating the accepted instruction operation. The GUI components may be displayed after receiving the report from the keyword extraction unit 123. Alternatively, the GUI components may be initially displayed in an inactive mode, and be transited to an active mode upon receiving the report.

The associated information generating unit 125 generates a search query for an appropriate search site 20, based on the instruction operation accepted by the operation accepting UI 124, and the keyword extracted by the keyword extraction unit 123. The search site 20 is an arbitrary search site generally used in Web browsing. A single or a plurality of search sites 20 may be designated by the user, or may be predetermined. Further, for example, the associated information generating unit 125 may hold data indicating the instruction operations that can be accepted by the operation accepting UI 124, and the URLs of the search sites corresponding to the instruction operations, and may generate a search query for requesting search of the aforementioned keyword of the search site corresponding to an actually accepted instruction operation. The associated information generating unit 125 sends the generated search query to the communication unit 130. The associated information generating unit 125 acquires, via the communication unit 130, a search result corresponding to the search query. The associated information generating unit 125 analyzes the search result, and selects an appropriate associated Web page. The associated information generating unit 125 extracts, from the search result under preset rules, associated information that includes link information concerning the selected associated Web page, and inputs the extraction result to the result display UI 126. For example, the associated information may contain, as well as the link information concerning the associated Web page, an explanatory text concerning the associated Web page, the title of the associated Web page, the abstract of the associated Web page, the thumbnail associated to the associated Web page, etc.

The result display UI 126 displays the associated information obtained from the associated information generating unit 125. For example, the result display UI 126 displays the associated information on the screen of the browser 110 in a format that enables a link to the associated Web page to be selected. When the user fixes the selection of the associated information by click or touch input, the URL of the associated Web page is sent to the browser 110. The browser 110, in turn, acquires and displays the associated Web page.

The communication unit 130 transmits information to a network 10, such as the Internet or an intranet, and receives information from the network 10. In particular, the communication unit 130 receives the Web page corresponding to the URL designated by the browser 110, and transmits the search query, sent from the associated information generating unit 125, to the search site 20 via the network 10. The communication unit 130 may support various communication functions that include communication functions realized via a wireless LAN and a wired LAN, an infrared communication function, a short-range wireless communication function (e.g., Bluetooth), and a communication function realized via a universal serial bus (USB).

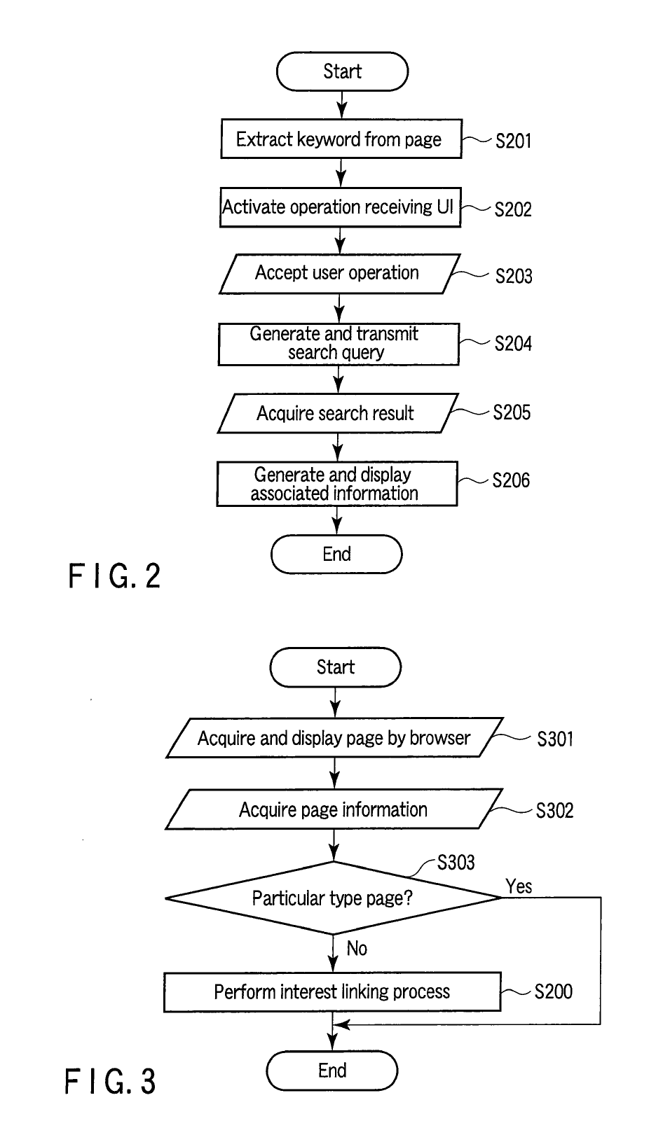

Referring now to FIG. 2, a description will be given of an interest linking process as part of the operation of the interest linking engine 120. The interest linking process is performed by the keyword extraction unit 123, the operation accepting UI 124, and the associated information generating unit 125 and a result display UI 126, which are incorporated in the interest linking engine 120.

When the interest linking process is started, the keyword extraction unit 123 extracts a keyword from a current Web page (step S201). After that, the keyword extraction unit 123 transmits, to the operation accepting UI 124, data reporting the completion of the keyword extraction, thereby starting the operation accepting UI 124 (step S202). The operation accepting UI 124 accepts an instruction operation from the user (step S203).

The associated information generating unit 125 generates a search query based on the keyword extracted at step S201, and the instruction operation accepted at step S203, and transmits the search query to the search site 20 via the communication unit 130 (step S204). The associated information generating unit 125 acquires a search result for the search query transmitted at step S204 via the communication unit 130 (step S205). Based on the search result acquired at step S205, the associated information generating unit 125 generates associated information, and displays the associated information on, for example, the screen of the browser 110 (step S206), which is the termination of the interest linking process.

Referring then to FIG. 3, the entire operation of the interest linking engine 120 will be described. As an example, the process shown in FIG. 3 is started whenever transition of Web pages, which are displayed by the browser 110, is performed.

During Web page browsing by the browser 110, Web pages are acquired and displayed by the browser 110 (step S301). The browser operation monitoring unit 121 detects transition of Web pages acquired and displayed by the browser 110. When the browser operation monitoring unit 121 detects transition of Web pages, the page type determination unit 122 acquires, from the browser 110, the information of the Web page currently displayed by the browser 110 (step S302).

The page type determination unit 122 determines based on the information acquired at step S302 whether the current Web page is a page of a particular type (step S303). If the current Web page is not the particular type page, the process proceeds to step S200. The process performed at step S200 is the interest linking process shown in FIG. 2. In contrast, if the current Web page is the particular type page, the process is finished. The interest linking process at step S200 may be replaced with an arbitrary supplementary service providing process for providing a supplementary service using the feature quantity of the current Web page.

The determination process by the page type determination unit 122 and pages of particular types will be described in detail.

The particular type indicates the type of a Web page to be kept secret. A certain number of particular types are preset. The page type determination unit 122 determines whether the current Web page conforms to one of the determination criteria set for the respective preset particular types, thereby acquiring a determination result.

An encrypted Web page (hereinafter also referred to as “the first particular type page” for convenience) may be defined as a page of one of the particular types. Since it is strongly possible that the first particular type page contains personal information or secret information concerning a user, the first particular type page should be kept secret. For instance, the page type determination unit 122 acquires the URL of the current Web page via an interface provided by the browser 110, to thereby determine whether the current Web page is the first particular type page, according to whether the URL begins with “https://.” Alternatively, the page type determination unit 122 acquires, via an interface provided by the browser 110, a port number used to receive the current Web page, to thereby determine whether the current Web page is the first particular type page, according to whether the port number is “443.” Yet alternatively, the page type determination unit 122 acquires, via an interface provided by the browser 110, information indicating whether the browser 110 has performed a decryption process based on a encryption algorithm to decrypt the current Web page, to thereby determine whether the current Web page is the first particular type page, according to this information.

Further, a Web page (hereinafter also referred to as “the second particular type page” for convenience) that requires entering a password when it is accessed may be defined as a page of another particular type. Since it is strongly possible that the second particular type page aims to allow only authenticated users to access the page, the second particular type page should be kept secret. The page type determination unit 122 can acquire, via an interface provided by the browser 110, information indicating whether the current Web page has required BASIC authentication, Digest authentication, etc., to thereby determine whether the current Web page is the second particular type page, according to the acquired information.

Furthermore, a Web page (hereinafter also referred to as “the third particular type page” for convenience) obtained by transition from a Web page that requires a password when it is accessed may be defined as a page of yet another particular type. Since it is strongly possible that the third particular type page is a private Web page, such as a page for the exclusive use of members, a personal space, etc., and contains personal information and/or secret information, the third particular type page should be kept secret. For instance, in the Web page accessed immediately before transition to the current Web page, the browser 110 may provide an interface for holding information that has been obtained based on the operation of a user, and indicates whether a password has been input into a form, such as a text box dedicated to password input, (i.e., whether authentication has been required), and externally publishing that authentication in the Web page immediately before the current Web page has succeeded to thereby realize transition to the current Web page. If the browser 110 provides such an interface as this, the page type determination unit 122 can acquire, from the interface, the information indicating that the authentication has been required in the Web page immediately before the current Web page, thereby determining whether the current Web page is the third particular type page, using the information as a determination criterion. Further, for example, the browser 110 may provide an interface for acquiring its own Cookie and externally publishing the same. If the browser 110 provides such an interface as this, the page type determination unit 122 can acquire the Cookie from the interface, and detect based on the Cookie whether the current Web page is a Web page that requires a password. Using the detection result based on the Cookie as a determination criterion, the page type determination unit 122 can determine whether the current Web page is the third particular type page. By thus using detection result based on the Cookie as a determination criterion, not only the Web page, to which transition is made from the Web page that required password input, but also a private page, to which further transition is made from, for example, a page for the exclusive use of members, are determined to be third particular type pages.

Yet further, a Web page acquired via an intranet (hereinafter also referred to as “the fourth particular type page” for convenience) may be defined as a page of a further particular type. Since it is strongly possible that the fourth particular type page is allowed to be accessed only by limited users, the fourth particular type page should be kept secret. The page type determination unit 122 can acquire the URL of the current Web page via an interface provided by the browser 110, to thereby determine whether the current Web page is the fourth particular type page, according to, for example, whether the URL begins with “¥¥.”

By excluding pages of the above-described particular types from keyword extraction targets, a keyword extracted from a Web page to be kept secret can be prevented from leakage. However, part of Web pages determined particular type pages may raise no problem even if they are treated as extraction targets. For instance, Web pages for news at a site for members only may be determined to be pages of the aforementioned second or third particular type. However, the content may be widely published, or users may wish to obtain information associated with it. It is useful in enhancing users' convenience to enable such a Web page to be designated as an exception. More specifically, a so-called white list may be defined in a memory that can be accessed by the page type determination unit 122. The white list may store, for example, part or all of the URLs of the Web pages designated as exceptions. The content of the white list may be set by a user, or the designer, manufacturer or sales parson of a software module corresponding to the interest linking engine 120 or the information processing apparatus 100. If the current Web page is one of the above-mentioned designated exceptional pages, the page type determination unit 122 transmits a keyword extraction request to the keyword extraction unit 123 even if it is determined that the current Web page is one of the particular type pages. Alternatively, the page type determination unit 122 may determine before the particular type page determination process whether the current Web page is one of the above-mentioned designated exceptional pages, and may omit the particular type page determination process and transmit a keyword extraction request to the keyword extraction unit 123, if the current Web page is one of the designated exceptional pages.

As described above, in the information processing apparatus according to the first embodiment, before extracting a feature quantity from the current Web page, it is determined whether the current Web page is one of the particular type pages. If the current Web page is one of the particular type pages, extraction of a feature quantity from the current Web page is omitted. Accordingly, the information processing apparatus of the first embodiment can suppress extraction of a feature quantity from a Web page to be kept secret and leakage of the same to the outside. Further, the user of the information processing apparatus of the first embodiment is free from feeling of discomfort involved by a supplementary service that is provided to the user based on a feature quantity (e.g., personal information concerning the user) extracted from the Web page to be kept secret. In addition, the information processing apparatus of the first embodiment can eliminate unnecessary costs, such as a calculation cost for extracting a feature quantity, and a communication cost for transmitting a search query to the outside, if the current Web page is a Web page to be kept secret.

### Second Embodiment

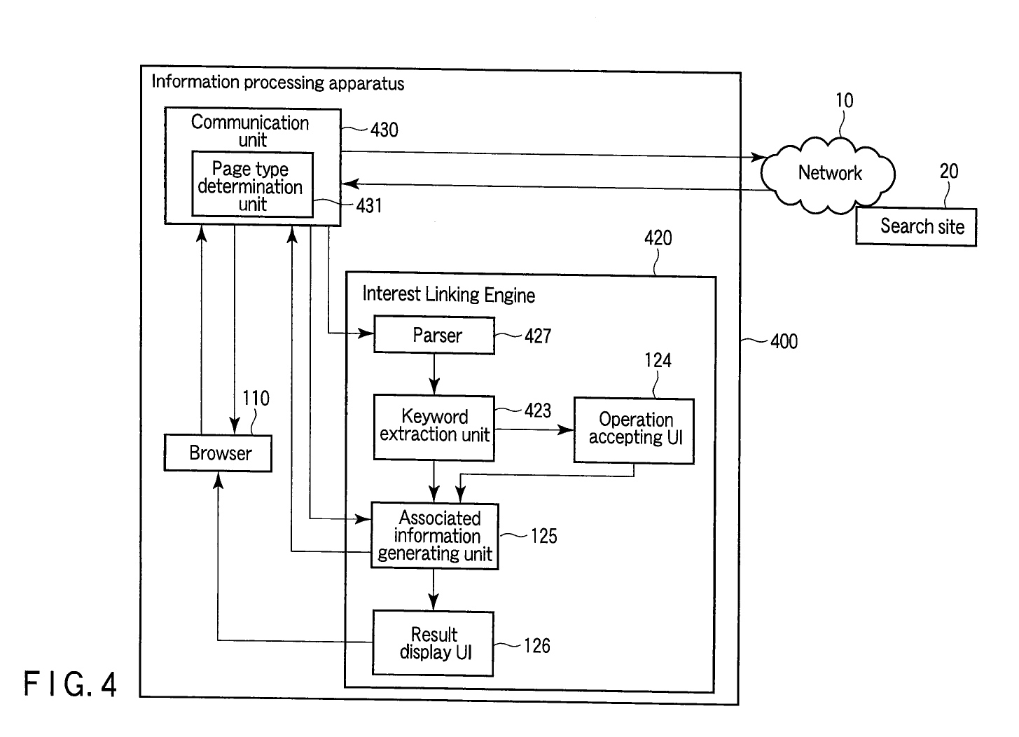

As shown in FIG. 4, an information processing apparatus 400 according to a second embodiment of the invention comprises a browser 110, an interest linking engine 420 and a communication unit 430. The information processing apparatus 400 is an arbitrary apparatus usable to browse Web pages, such as a mobile phone, a PC, a portable media player, a video game machine, a TV set. Further, the information processing apparatus 400 has a fundamental hardware configuration of a processor, a memory, a display, etc., although they are not shown. In the description below corresponding to FIG. 4, elements similar to those of FIG. 1 are denoted by corresponding reference numbers, and different elements will be described mainly.

The communication unit 430 has functionality equivalent or similar to that of the communication unit 130 shown in FIG. 1, but includes a page type determination unit 431. The page type determination unit 431 is a software module installed in the information processing apparatus 400 or in the communication unit 430.

If the data (hereinafter referred to simply as “the received data”) received by the communication unit 430 via the network 10 indicates a Web page, the page type determination unit 431 determines whether the received data represents a page of a particular type. The determination as to whether the received data represents a Web page may be performed by the page type determination unit 431 or by a functional unit (not shown) incorporated in the communication unit 430. In the description below, suppose that the page type determination unit 431 also determines whether the received data represents a Web page.

If the received data does not indicate a particular type page, the page type determination unit 431 inputs the received data to the interest linking engine 420. In the second embodiment, the page type determination unit 431 inputs the received data to the browser 110 regardless of whether the received data represents a particular type page. In contrast, if a functional unit other than the page type determination unit 431 performs a determination as to whether the received data represents a Web page, it inputs the received data to the browser 110 only when the received data represents the Web page.

The interest linking engine 420 comprises a keyword extraction unit 423, an operation accepting UI 124, an associated information generating unit 125, a result display UI 126 and a parser 427. The parser 427 analyzes the received data output from the page type determination unit 431 to generate a current Web page.

The keyword extraction unit 423 extracts a keyword from the source data of the current Web page, like the above-described keyword extraction unit 123. For instance, the keyword extraction unit 423 acquires the source data of the current Web page from the parser 427. After the keyword extraction unit 423 completes the keyword extraction, it reports the completion to the operation accepting UI 124. Note that since the keyword extraction unit 423 can acquire the source data of the current Web page from the parser 427, the browser 110 does not have to provide the keyword extraction unit 423 with an interface for enabling the source data of the current Web page to be used by external.

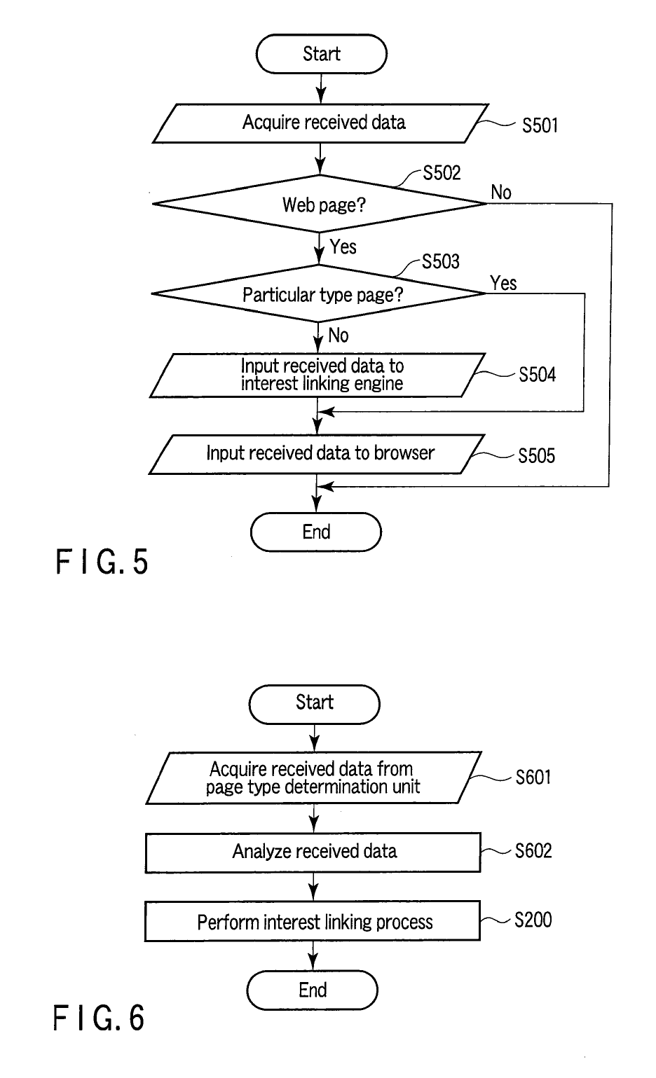

Referring then to FIG. 5, a description will be given of the operation of the page type determination unit 431.

Firstly, the page type determination unit 431 acquires data received by the communication unit 430 (step S501). The page type determination unit 431 determines whether the received data acquired at step S501 indicates a Web page (step S502). If it is determined at step S502 that the received data represents the Web page, the process proceeds to step S503, whereas if it is determined at step S502 that the received data does not indicate the Web page, the process finishes. The determination process of the page type determination unit 431 will be described in detail later.

At step S503, the page type determination unit 431 determines whether the received data acquired at step S501 indicates a particular type page. If it is determined at step S503 that the received data represents the particular type page, the process proceeds to step S505, whereas if it is determined that the received data does not indicate the particular type page, the process proceeds to step S504.

At step S504, the page type determination unit 431 inputs, to the interest linking engine 420, the received data acquired at step S501, whereby the process proceeds to step S505. At step S505, the page type determination unit 431 inputs, to the browser 110, the received data acquired at step S501, whereby the process finishes.

As a result of the above-described operation of the page type determination unit 431, if the received data represents a Web page of a particular type, it is not input to the interest linking engine 420, although it is input to the browser 110. In contrast, the received data represents a Web page that is not of a particular type, it is input to both the interest linking engine 420 and the browser 110.

Referring now to FIG. 6, the operation of the interest linking engine 420 will be described.

Firstly, the parser 427 in the interest linking engine 420 acquires received data from the page type determination unit 431 (step S601). As aforementioned, this received data is a Web page but is not of a particular type. The parser 427 analyzes the received data acquired at step S601, and generates a current Web page (step S602).

The keyword extraction unit 423, the operation accepting UI 124, the associated information generating unit 125 and the result display UI 126 performs an interest linking process on the current Web page generated at step S602 (step S200). The interest linking process at step S200 may be the process shown in FIG. 2, or may be replaced with an arbitrary supplementary service providing process for providing a supplementary service using the feature quantity of the current Web page.

The determination process by the page type determination unit 431 will be described in detail. In particular, the part of this process, which differs from that of the page type determination unit 122, will be mainly described.

The page type determination unit 431 can determine whether the received data represents a page of the aforementioned first particular type. For instance, the page type determination unit 431 acquires the URL of the received data from the communication unit 430, and determines whether the received data represents a page of the aforementioned first particular type, according to whether the URL begins with “https://.” Alternatively, the page type determination unit 431 acquires, from the communication unit 430, a port number used to receive the current Web page, to thereby determine whether the current Web page is the first particular type page, according to whether the port number is “443.”

The page type determination unit 431 can determine whether the received data represents a page of the aforementioned second particular type. For instance, the page type determination unit 431 acquires the HTTP header of the received data from the communication unit 430, and analyzes the HTTP header. The page type determination unit 431 determines whether the received data represents a page of the aforementioned second particular type, according to whether “401” is set as the response code of the HTTP header.

Further, the page type determination unit 431 can determine whether the received data represents a page of the aforementioned third particular type. For instance, the browser 110 may provide an interface for acquiring its own Cookie and externally publishing the Cookie. If the browser 110 provides such an interface, the page type determination unit 431 can acquire the Cookie of the browser 110 via the interface to thereby check based on the acquired Cookie whether the current Web page is a Web page that requires a password. The page type determination unit 431 can determine whether the received data represents a Web page of the third particular type, according to the check result based on the Cookie. By thus using, as a determination criterion, the check result based on the Cookie, even a private page (i.e., received data indicating the private page), to which further transition is made from, for example, a page dedicated to members only, can be determined as a page of the third particular type, as well as a Web page to which transition is made from the Web page that required password input.

Furthermore, the page type determination unit 431 can determine whether the received data represents a page of the aforementioned fourth particular type. For instance, the page type determination unit 431 acquires, from the communication unit 430, an IP address assigned to the source of the received data, and determines whether the received data represents a page of the aforementioned fourth particular type, according to whether the IP address is a global IP address (if the IP address is the global IP address, the page type determination unit 431 determines that the received data does not indicate the fourth particular type page).

In a memory that can be accessed by the page type determination unit 431, the aforementioned white list may be defined. The content of the white list may be set by a user, or by the designer, manufacture or sales parson of a software module corresponding to the page type determination unit 431 or the page type determination unit 431. If the received data represents one of the above-mentioned designated exceptional pages, the page type determination unit 431 inputs the received data to the interest linking engine 420 even if it is determined that the current Web page is one of the particular type pages. Alternatively, the page type determination unit 431 may determine before the particular type page determination process whether the received data represents one of the designated exceptional pages, and may omit the particular type page determination process and input the received data to the interest linking engine 420, if the received data represents one of the designated exceptional pages.

As described above, in the information processing apparatus of the second embodiment, it is determined whether the received data represents a Web page of one of the particular types, before the received data is analyzed to generate a current Web page and extract a feature quantity therefrom. If the received data is determined to represent a Web page of one of the particular types, feature quantity extraction is omitted. Thus, the information processing apparatus of the second embodiment suppresses extraction of a feature quantity from a Web page to be kept secret, and leakage of the feature quantity to the outside. The information processing apparatus of the second embodiment also suppresses provision, to the user, of a supplementary service based on a feature quantity (e.g., personal information on a user) extracted from a Web page to be kept secret, thereby suppressing user's feeling of discomfort due to the supplementary service. Further, when the current Web page is a Web page to be kept secret, the information processing apparatus of the second embodiment can eliminate unnecessary costs, such as a calculation cost for extracting a feature quantity, and a communication cost for transmitting a search query to the outside. Yet further, since the information processing apparatus of the second embodiment performs determination of particular type pages basically without acquiring information from the browser, it is useful even when the browser does not provide interfaces to external.

The present invention is not limited to the above-described embodiments, but may be modified in various ways without departing from the scope. Various aspects can be realized by appropriately combining the configuration elements disclosed in the embodiments. For instance, some of the disclosed configuration elements may be deleted. Some configuration elements of different embodiments may be combined appropriately.

For instance, a program for realizing the processes in each embodiment can be stored in a computer readable storing medium. Various storing mediums, such as a magnetic disk, optical disks (a CD-ROM, CD-R, DVD, etc.), a magnetooptic disk (for example, an MO), and a semiconductor memory, can be used. It is sufficient if the storing mediums are computer readable ones.

Furthermore, the program for realizing the processes in each embodiment may be stored in a server computer connected to a network such as the Internet, and be downloaded therefrom to a client computer via the network.

What is claimed is:

1. An information processing apparatus comprising:
a monitoring unit configured to monitor transition of Web pages displayed by a browser;
a determination unit configured to determine whether a current Web page is a page of a particular type when the transition of the Web pages displayed by the browser has occurred;
an extraction unit configured to extract a feature quantity from the current Web page when the current Web page is not the page of the particular type; and
a providing unit configured to provide a supplementary service related to the current Web page, using the extracted feature quantity.

2. The apparatus according to claim 1, wherein the page of the particular type includes an encrypted Web page.

3. The apparatus according to claim 1, wherein the page of the particular type includes a Web page that requires a password when accessed.

4. The apparatus according to claim 1, wherein the page of the particular type includes a Web page obtained by transition from a Web page that requires a password when accessed.

5. The apparatus according to claim 1, wherein the page of the particular type includes a Web page acquired via an intranet.

6. The apparatus according to claim 1, further comprising a storage unit configured to store a white list including a designated Web page, and wherein the determination unit further determines whether the current Web page is the designated Web page, and the extraction unit extracts the feature quantity from the current Web page when the current Web page is the designated Web page.

7. An information processing apparatus, comprising:
a determination unit configured to determine whether received data is a page of a particular type when the received data is a Web page;
a parser configured to analyze the received data and generate a current Web page when the received data is the Web page and is not the page of the particular type;
an extraction unit configured to extract a feature quantity from the current Web page; and
a providing unit configured to provide a supplementary service related to the current Web page, using the extracted feature quantity.

8. The apparatus according to claim 7, wherein the page of the particular type includes an encrypted Web page.

9. The apparatus according to claim 7, wherein the page of the particular type includes a Web page that requires a password when accessed.

10. The apparatus according to claim 7, wherein the page of the particular type includes a Web page obtained by transition from a Web page that requires a password when accessed.

11. The apparatus according to claim 7, wherein the page of the particular type includes a Web page acquired via an intranet.

12. The apparatus according to claim 7, further comprising a storage unit configured to store a white list including a designated Web page, and wherein the determination unit further determines whether the received data is the designated Web page, and the parser analyzes the received data, and generates the current Web page when the received data is the designated Web page.

13. An information processing apparatus comprising:
an acquiring unit configured to acquire a Web page;
a determination unit configured to determine whether an acquired Web page is a page of a particular type;
an extraction unit configured to extract a keyword from the acquired Web page when the acquired Web page is not the page of the particular type; and
a generation unit configured to generate a search query based on the keyword.

14. The apparatus according to claim 13, wherein the page of the particular type includes an encrypted Web page.

15. The apparatus according to claim 13, wherein the page of the particular type includes a Web page that requires a password when accessed.

16. The apparatus according to claim 13, wherein the page of the particular type includes a Web page obtained by transition from a Web page that requires a password when accessed.

17. The apparatus according to claim 13, wherein the page of the particular type includes a Web page acquired via an intranet.

18. The apparatus according to claim 13, further comprising a storage unit configured to store a white list including a designated Web page, and wherein the determination unit further determines whether the acquired Web page is the designated Web page, and the extraction unit extracts the keyword from the acquired Web page when the acquired Web page is the designated Web page.
